(19) United States
(12) Patent Application Publication
(10) Pub. No.: US 2005/0266882 A1
(43) Pub. Date: Dec. 1, 2005

(54) Apparatus and method for implementing file recording in a resource-constrained digital radio

(76) Inventors: Mahmut Ciftci, Missouri City, TX (US); Burc Simsek, SugarLand, TX (US)

Correspondence Address: TEXAS INSTRUMENTS INCORPORATED, P O BOX 655474, M/S 3999, DALLAS, TX, 75265, US

(21) Appl. No.: 10/853,070

(22) Filed: May 25, 2004

(51) Int. Cl. H04M 1/00

(52) U.S. Cl. 455/558; 455/556.1; 455/557

(57) ABSTRACT

In this patent, a timer-based recording scheme is developed to circumvent the internal delays associated with Flash based media when reading and writing from media such that the low level card access, rather than blocking the processor while writing to or reading from Media, uses a direct-memory-access (DMA) peripheral and then periodic interrupts (using an empirically determined period) to check whether write/read process is completed. If it is completed, then next write/read process is initiated. This process will be repeated until the recording is finished. At a higher level, to record in FAT format, the FAT table and Root Directory table are cached into the processor memory during initialization. Rather than updating those tables in the media, they are updated in processor memory (due to faster access times) while recording. Finally, those tables are written back to the media once recording is finished.

### FIELD OF THE INVENTION

This invention relates generally to digital radios and, more particularly, to storage of audio and data signals received by a digital radio in a multimedia card.

### BACKGROUND OF THE INVENTION

The digital radio market has grown rapidly in recent years from a developmental and experimental system to a commercially accepted system. Most of the presently available commercial products are capable of decoding at least one audio channel and providing audio material to a user. The recording of decoded digital radio audio material to a non-volatile medium such as a hard disk drive (HDD) or Flash memory, while technically possible, has only recently started to emerge as a major application. There are several reasons for this delay, legal issues concerning the recording of digital audio material, consumer behavior and acceptance of a new feature, and technical difficulties in the implementation of the recording feature. In the current digital radio processors, a significant portion of the processing and user interface is performed on the same digital signal processor. From a technical point of view, it would be better to provide a processor for the decoding of the incoming signals and a separate processor for the user interface and audio recording, from a commercial perspective, the single “do-it-all” processor is the most cost effective. In other words, the available resources of the device in question provide a limitation of the performance. Decoding a digital radio signal stream is resource intensive in terms of both memory usage and processor cycle requirements. Consequently, adding another feature can be a technical challenge.

The recording of a digital radio signal stream is performed today in several different architectures. These architectures can be classified into the following different implementation categories:
1. Separate processor for recording: In this approach, the digital radio stream is decoded and the audio output is provided to a separate processor. This processor is responsible for communicating and controlling the recording media. The strength of this approach is its robustness and ease of design. Such a system has more resources (because of the presence of multiple processors) that can be utilized and is robust in that the implementation could be used across various digital radio standards. The weakness of this implementation is the cost. Because of the presence of more than one processor (and the associated support circuitry), an inherently higher cost is associated with such a system.
2. Complete integrated implementation in hardware: In this approach, a complete system on a chip implemented completely in hardware can be utilized. This system would not have the problem of software or processor resources because the requirements would be implemented in during the design phase of the chip. However, to design a custom chip for each application is expensive and time-consuming. In general terms, a complete hardware solution to this sort of problem typically requires more silicon area and ends up being more expensive on a per product basis. Also, a complete hardware solution will not be robust in the sense that the solution can not be reprogrammed or upgraded as standards evolve.
3. Mixed hardware and software approach: In this approach a software processor is used in conjunction with an array of custom-based circuitry built into the device. This approach is a better solution than the previous one since a majority of the processing is performed in software, but hardware peripherals are available to the main processor to make the tack easier in performing the requested operations. This solution is similar to the first solution, but a dedicated processor is now built into the main processor. This approach bears the same burdens as the first solution, but is even more costly because a custom solution has to be implemented.
4. Software approach on a capable device: A hybrid approach using a peripheral to perform the most resource intensive task (such as moving memory around) is most often the best solution because it does not incur additional cost (assuming that the correct mix of peripherals is available). An example of this approach is direct memory access controller and the multimedia card peripheral. This peripheral allows the contents of memory to be moved around without affecting the cycles or resources of the main processor. The multimedia card peripheral allows the processor to communicate with the recording medium with minimal overhead and is not really complicated or big enough to be a separate processor. With peripherals such as this, a robust and low-cost solution can be obtained rather than a complete re-design of a system on a chip.

While all of the above approaches technically offer a solution to the problem of recording a digital radio signal stream to a non-volatile medium, the most cost effective one is the last of the above-identified approaches. However, even with the correct mix of peripherals on the device, the system can be severely overloaded; in which case, the central processing unit will not have enough cycles or memory to perform the recording process.

Referring to FIG. 1, a block diagram of a digital radio 10 baseband module capable of advantageously using the present invention is shown. The broadcast digital radio signal is received by antenna 5. The antenna is connected to RF receiver unit 101. The RF receiver unit 101 down converts the received signals to a bandwidth that the analog to digital converter 102 can sample. The output signals from the receiver unit 101 are applied to the analog to digital converter unit 102 and once the signal is digitized, the output signals of the analog-to-digital converter unit 102 are applied to the input port 103 associated with baseband processor 10. The data received from the input port 103 is stored to memory unit 106 using the direct memory access (DMA) controller unit 104, thus not loading the CPU 105. The DMA controller is capable of copying data from the peripherals of the baseband processor to memory without interrupting the CPU. Once a significant amount of data (an input block) has been buffered in memory 106 by the DMA controller 104, the CPU 105 will process the input data and decode the received signal. The output from this process (output block) is stored back into the memory unit 106. The data stream from the direct memory access unit is stored in the memory unit 104 in blocks of signals. The output block, at this point, may be an audio or data signal stored in memory unit 106. The output block of data is then transferred from memory unit 106 via the direct memory access unit 104 to the Flash controller 107 and/or to the output port 108 (in the audio case). The Flash controller 107 will communicate with the Flash device 115 and store the data/audio. For an audio signal, the signals applied to the output port 108 are converted to analog signals in the analog to digital converter unit 109. The analog signals are then amplified using a power amplifier unit 110 and sent to the speaker unit 111.

The present invention relates to the storage of the decoded audio or data signals from the memory 106 to a connected Flash device 115. While FIG. 1 shows a direct connection of the output data being sent from the memory 106 to the Flash controller 107, this connection may also be directly sent through the CPU 105. In this case, the CPU 105 will have to halt what ever it is doing (decoding a signal) and spend time sending data to the Flash controller. This is a very straight forward approach however it is usually not feasible due to resource limitations, mainly the amount of time it would take to do both decode of a signal and storing of the data to the Flash medium 115. The main limitation for this sort of storage is the internal delays and latencies associated with the storage mediums themselves. Usually the Flash controller 107 has to initiate the transfer by sending a start command that contains the type of instruction (read/write/status etc. . . ) the address and length if required or any other custom command/parameter set associated with the device. In reply to this, the Flash device will usually buffer the data or perform some sort of task that will be much slower than the internal clock of the baseband processor. Thus the CPU 105 usually will have to wait for the Flash to become available after performing an operation. This wait time cannot be afforded in a real-time decoding environment.

Once a command has been sent to the Flash 115, the Flash Controller 107 has to then determine if the Flash 115 has acknowledged and completed the command by polling the Flash 115 since most devices are serial and do not have specific hardware capability to provide this on an separate digital pin that can be used to interrupt the CPU 105. This will usually mean that the Flash Controller 107 has to be used by the CPU 105 to poll for the status of the last command and to determine if the Flash 115 is ready for the next transfer.

A need has therefore been felt for apparatus and an associated method having the feature that processing of the audio signal stream by a digital radio is not interrupted by the storage of audio or data signals to a Flash based device. It would still another feature of the apparatus and associated method to provide a control signal to indicate that the audio or data in the memory unit has been stored in a storage media for which the delay has been reduced. It would be a more particular feature of the apparatus and associated method to provide a control signal indicating the storage of the audio or data in a storage media that is not provided by the apparatus storing the signal groups.

### SUMMARY OF THE INVENTION

The aforementioned and other features are accomplished, according to the present invention, by providing in the digital radio, a timer that is activated when the transfer of processed data is begun between the memory unit and the storage unit. The clock is programmed to provide a signal after a time empirically determined to be slightly longer than the actual time for the transfer. The clock signal is used to initiate a new transfer using the direct memory control unit in place using the CPU to check for the completion of the previous transfer thus eliminating the need for the CPU to stall other processing, mainly that decoding loops. Because the control signal is generated after a specific amount of time rather than an actual event, the transfer of signal groups is not interrupted in unexpected times.

Other features and advantages of the present invention will be more clearly understood upon reading of the following description and the accompanying drawings and claims.

### BRIEF DESCRIPTION OF THE DRAWINGS

FIG. 1 is block diagram illustrating the principal components of a digital radio according to the prior art.

FIG. 2 is a block diagram of the digital radio according to the present invention.

FIG. 3A illustrates the timing signals in a system where the CPU is used to store the audio data signal according to prior art. FIG. 3B illustrates the timing signals where the CPU polls the transfer completion signal where as FIG. 3C illustrates the timing diagrams using the timer as a trigger for transfer as per the current invention.

### DESCRIPTION OF THE PREFERRED EMBODIMENT

### 1. Detailed Description of the Drawings

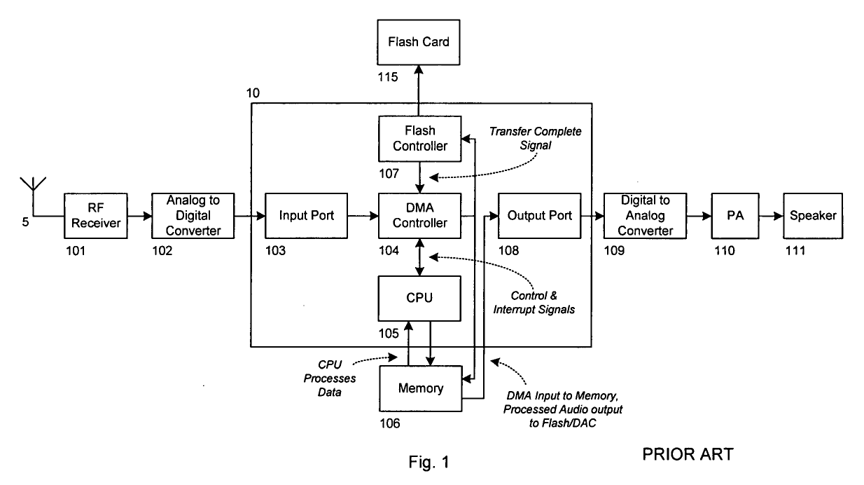

FIG. 1 has been described with reference to the related art.

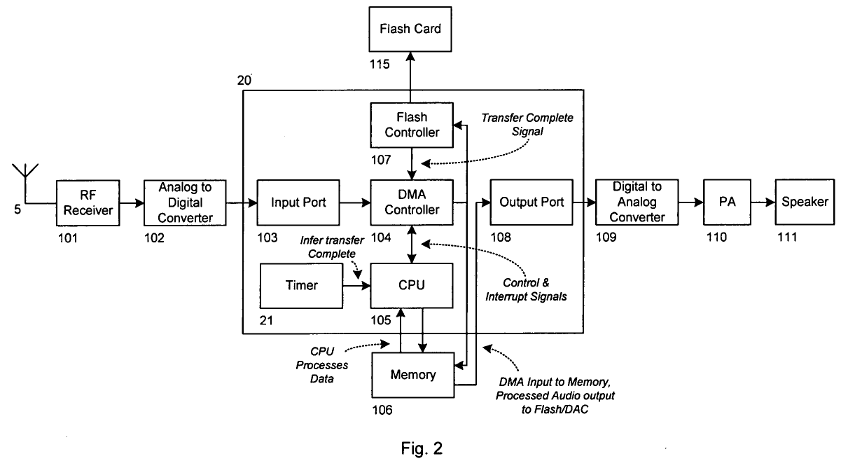

Referring to FIG. 2, a block diagram of a digital radio according to the present invention is shown. Comparison with the block diagram of the digital radio baseband 10 shows that a timer 21 has been added to the digital radio baseband 20. The timer 21 generates a periodic clock signal which signals to the CPU 105 that it should start another transfer. The operating system on the CPU will schedule this transfer at the earliest convenience, but the transfer initiation is a simple command to start the DMA so the interrupt can even be a high priority hardware interrupt, rather than a low priority software interrupt or task. The period of the clock generated by the timer 21 is empirically determined by the time for transfer of data from the memory unit to the Flash card 115.

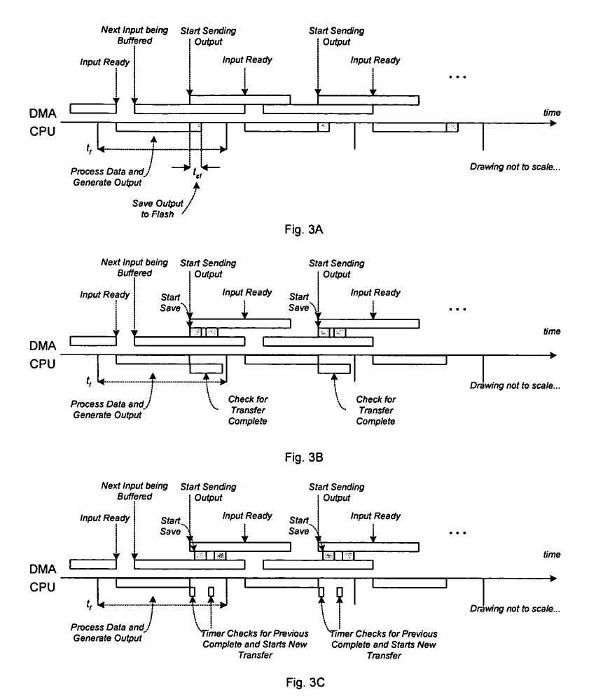

Referring to FIG. 3A, FIG. 3B and FIG. 3C, FIG. 3A illustrates how much time the CPU would have if it were to transfer the data to the Flash without using a DMA channel. This is clearly a small amount of time and in FIG. 3B the advantage of using the DMA channel is observed. However, in FIG. 3B the CPU still has to check to see if the previous transfer has completed before starting another. FIG. 3C shows the amount of time the CPU will spend in the timer interrupt to start a DMA and exit. When the timer generates another interrupt, the previous one will have completed. In the case where the empirically determined number is not enough, the interrupt will exit and try again the next time.

### Operation of the Preferred Embodiment

The operation of the present invention can be understood as follows. To determine the completion of a transfer to the Flash device a status check command must be performed (or some cards may actually have a complete signal where this is not required). The procedure to check for this transfer complete status can delay the current transfer in process as explained before and also put a burden on the processor since it has to stop decoding to continuously check for this event. This procedure is replaced with a periodic event generated by the timer peripheral which signals to the CPU to start another transfer. The period of this event is determined empirically by lab testing for various different Flash devices.

It can be desirable to store the blocks of data in the storage medium in the FAT file format. Since the FAT table is a linked list of cluster information that denotes which parts of the media contain which files, a write can take a significant amount of time if the disk is very full and highly fragmented. With access to the Flash device taking a significant amount of time, it will be very difficult to perform this by trying to manipulate the FAT on the Flash device itself. To accomplish this task, the FAT and Root directory sectors are replicated in the memory (internal or external) of the baseband device creating a cache of data that the processor can access very quickly. This reduces the amount of time the CPU will have to spend to find the sector in the media where the next data is to be written to. This memory serves as a cache memory unit until the entire sequence of blocks of data has been formatted in the FAT format and stored in the memory unit.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

1. A digital radio comprising:
a processor unit for processing an audio stream arranged in blocks of data;
a memory unit coupled to the processing unit, the memory unit storing processed blocks of data predetermined groups of memory locations;
a controller unit, the controller unit including apparatus for coupling to a storage medium, the controller unit storing the processed blocks of data in the storage medium;
an interface unit coupled to the controller unit and the memory unit, the interface unit transferring blocks of data from the memory unit to the controller unit; and
a clock unit, the clock unit initiating a timing sequence in response to a signal from the controller unit indicating the beginning of a storage of a block of data, the clock unit providing a signal to the processor unit for transferring the next sequential block of data to the predetermined memory locations.

2. The digital radio as recited in claim 1 wherein the length of the timing sequence is an empirically determined value.

3. The digital radio as recited in claim 2 wherein the length of the timing sequence permits the processed block of data has been removed from the memory locations prior to the storing of the next sequential block of data in the predetermined memory locations

4. The digital radio as recited in claim 3 wherein the interface unit is a direct memory access unit.

5. The digital radio as recited in claim 4 wherein the controller unit is a multimedia card controller unit and the storage unit is a multimedia card.

6. The digital radio as recited in claim 5 one wherein a plurality of blocks of data are arranged in a FAT file format prior to transfer to the controller unit.

7. A method of transferring blocks of data signals of processed audio signals from a digital radio to a storage unit, the method comprising:
beginning the storage of a block of processed audio signals from a processor unit to a group of memory locations in response to a time-out signal from a clock unit; and
initiating operation to the clock unit is response to a signal indicating the beginning of transfer of a block of processed data to the storage medium.

8. The method as recited in claim 7 further comprising empirically deriving the time out signal.

9. The method as recited in claim 8 further comprising providing a time out signal wherein the block of processed data is transferred from the memory unit prior to the storage of the next sequential block of processed data in the memory unit.

10. The method as recited in claim 9 wherein the processed data block is stored on a multimedia card.

11. The method as recited in claim 10 comprising transferring a block of process audio data from the memory unit through a direct memory access unit and a multimedia card controller unit to the multimedia card.

12. A digital radio comprising:
a processor unit for processing and incoming data stream;
a memory unit coupled to the processor unit, the processor unit transferring blocks of processed audio signals to predetermined memory locations in response to a timing signal;
a multimedia card controller unit, the memory transferring blocks of processed audio signals to the multimedia card controller unit; and
a clock unit for generating the timing signal of a preselected time after data is entered in the multimedia card controller unit.

13. The digital radio as recited in claim 12 wherein the preselected time is derived empirically.

14. The digital radio as recited in claim 13 wherein the empirically derived preselected time permits a block of processed audio signals to be removed from the predetermined memory location before the processor stores the next sequential block of processed audio signals in the predetermined memory locations.
